(19) United States
(12) Patent Application Publication
(10) Pub. No.: US 2006/0292537 A1
(43) Pub. Date: Dec. 28, 2006

(54) SYSTEM AND METHOD FOR CONDUCTING MULTIMEDIA KARAOKE SESSIONS

(75) Inventors: JOHN P. NUTE, MIDLAND, TX (US); QUINTON T. LAWSON, MIDLAND, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: ARCTURUS MEDIA, INC., MIDLAND, TX (US)

(21) Appl. No.: 11/160,497

(22) Filed: Jun. 27, 2005

(51) Int. Cl. G09B 5/00

(52) U.S. Cl. 434/307 A; 434/307 R

(57) ABSTRACT

A system and method for conducting a media session includes a host station, a client station, and a playlist station networked together. Clients search for multimedia files (audio, video, karaoke, and/or images files) on the system and make media selections from touchscreen or other interactive displays or devices. The host station generates a rotating queue of the requested media selections and cycles through the media selections in the queue. Processed data of the media selections is sent to peripheral devices, such as an audio system and a monitor. The playlist station is communicatively connected to a monitor or other device for publicly displaying or otherwise conveying playlist information to clients at a venue. The system is at least partially operable in an automated fashion. For example, one or more of the acts of processing search queries and requests from the users, storing the requests in the rotating queue, and cycling through the requests in the rotating queue can be automated without requiring manual intervention by a DJ/KJ or other moderator.

### FIELD OF THE PRESENT DISCLOSURE

The subject matter of the present disclosure relates to a system and method for conducting multimedia sessions having audio, video, karaoke, and/or still images at a venue.

### BACKGROUND OF THE PRESENT DISCLOSURE

Karaoke has become a popular form of entertainment at various venues worldwide. During a typical karaoke session, a performer sings to pre-recorded music of a karaoke song while the changing lyrics for the song are displayed on a screen. In its basic form, a prior art karaoke system has an audio system (microphone, amplifier, speakers, CD player, etc.) and a video system (monitor, projector, etc.).

Typically, a disk jockey/karaoke jockey (DJ/KJ) must manually set up and configure a prior art karaoke system. For example, to set up some prior art karaoke systems, the DJ/KJ must maintain a physical library of individual CD/CD+G (Compact Disk plus Graphics) disks for use during a karaoke session. Alternatively, the DJ/KJ must manually store and organize karaoke songs in a database on a computer hard drive.

To set up some prior art karaoke systems, the DJ/KJ must also typically maintain a printed list of all his/her karaoke songs. Often, the printed list, which is kept in notebooks, lists the available karaoke songs in alphabetical order by titles or original performing artists. As the DJ/KJ adds new karaoke songs to the library, the DJ/KJ must make temporary lists of the recent additions and keep the temporary lists in the back of the notebooks until they have an opportunity to update the entire lists in the notebooks. Using the printed lists of available karaoke songs is inconvenient, and maintaining the printed lists is a constant, costly, and time-consuming task for the DJ/KJs.

During a karaoke session, the DJ/KJ must also manually operate functions of prior art karaoke systems. For example, the DJ/KJ must first solicit requests for karaoke songs from people at the venue who have made choices from the printed lists of songs in the DJ/KJ's library. Then, the DJ/KJ must manually coordinate the order of the requested songs, load the karaoke songs to be played, operate video and audio equipment, and announce the next performer, among other manual tasks.

A commercially available software utility, HOSTER™ by Micro Technology Unlimited of North Carolina, has been developed to enable a DJ/KJ to load, store, and play karaoke files on a personal computer. The DJ/KJ uses HOSTER™ to import karaoke files from CD+G type discs and encode them into a KMA format on the computer. The KMA format consists of both raw CD+G formatted karaoke video data, and “lossy” compressed (with resultant reduced fidelity), Windows Media Audio (WMA) formatted audio data. Once the files are loaded onto the computer, the DJ/KJ prints a physical list of the karaoke files stored on the computer with the software.

During a karaoke session, performers review the printed list and select songs to perform. Performers then ask the DJ/KJ to enter their selections within the software. Often, these requests may be made verbally to the DJ/KJ or made with written notes, which may be incomplete or illegible. The DJ/KJ locates the requested song on the computer using the software. The software enables the DJ/KJ to search the stored files by brand or by book ID. Brand searches are based on the producer, the disc number, and the track number of the song. Book ID searches are based on a number assigned by the software to each song. As karaoke files are added to the computer, for example, the software assigns numbers (i.e., book IDs) sequentially to the added files. These sequential numbers are printed next to the name of the song in the printed song list reviewed by the performers. Once the selected song is located in the database, the software queues the song to be played. The performer cannot determine the place of her song in the queue. Moreover, the performer must ask the DJ/KJ to estimate the amount of time the performer must wait to sing her song. When the performer's song comes to the top of the queue, the DJ/KJ announces the song, and the performer comes to the stage to perform. Finally, the DJ/KJ starts the song using the software.

Even with the advent of such prior art techniques for storing and queuing karaoke files for performers, a need exists in the art for more automated techniques to conduct multimedia sessions and to reduce the need for manual management by a DJ/KJ. In addition, a need exists in the art for more automated techniques to keep constantly changing song libraries up-to-date and to facilitate selection of available songs by performers at the venue.

The subject matter of the present disclosure is directed to overcoming, or at least reducing the effects of one or more of the problems set forth above.

### SUMMARY OF THE DISCLOSURE

A system and method for conducting a media session includes a host station for a DJ/KJ moderator, a client station for clients or performers, and an active playlist station. The host station, the client station, and the playlist station are networked together. Clients use interactive touchscreen displays at the client stations to search for multimedia files (audio, video, karaoke, and/or image files) on the system and to make media selections of the available multimedia files. The host station generates a rotating queue of the requested media selections and cycles through the media selections in the queue. Processed data of the media selections is sent to peripheral devices, such as an audio-video system and a monitor. The playlist station is connected to a monitor for publicly showing the active playlist to the clients at a venue. The system is at least partially operable in an automated fashion during the multimedia session. For example, one or more of the acts of receiving the requests from the clients, storing the requests in the rotating queue, and cycling through the requests in the queue in a managed rotation are preferably automated during normal operation. Preferably, the system enables the DJ/KJ moderator to intervene manually in any of the automated features of the system.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 schematically illustrates an embodiment of a multimedia system according to certain teachings of the present disclosure.

FIG. 2 schematically illustrates elements of the disclosed system of FIG. 1.

FIGS. 3A-3F illustrate embodiments of touchscreen interfaces available to clients at a venue.

FIG. 4 illustrates an embodiment of a graphical user interface available to a host moderator of the disclosed system.

FIG. 5 illustrates an embodiment of an option interface for the disclosed system.

FIG. 6 illustrates an embodiment of a media library control interface for the disclosed system.

FIGS. 7A-7B illustrate an embodiment of importer interfaces for the disclosed system.

FIG. 8 illustrates an embodiment of a list maker interface for the disclosed system.

FIG. 9 illustrates an embodiment of a public playlist available at a venue for the disclosed system.

While the disclosed system and method are susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

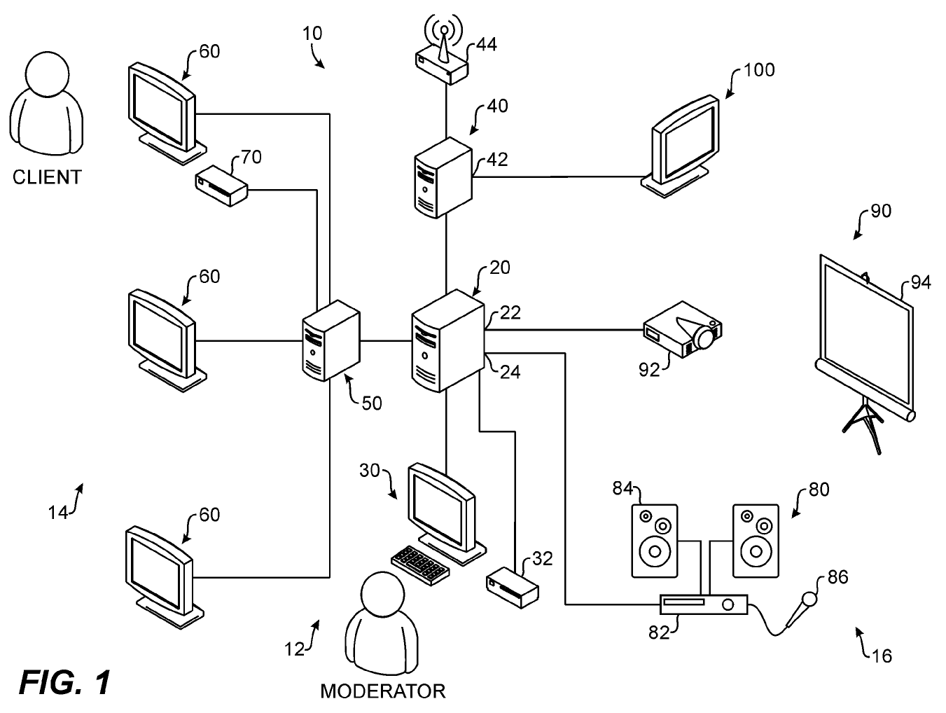

Referring to FIG. 1, a multimedia system 10 according to certain teachings of the present disclosure is schematically illustrated. The multimedia system 10 has hardware and software components networked together for conducting multimedia sessions having audio, video, karaoke, and/or still images. First, the disclosed system 10 has a central processing portion 12, which includes a host station 20 and a moderator terminal 30 in the present embodiment. The central processing portion 12 controls other portions of the system 10, stores multimedia files and data, and coordinates the multimedia session, among other functions disclosed herein. Preferably, the host station 20 and moderator terminal 30 are positioned together in a segregated location of a venue, such as a DJ/KJ booth where access to the host station 20 and terminal 30 is controlled. In a further embodiment, the host station 20 also includes an identification device 32 for identifying clients and configuring accounts for clients as described below. In one example, the identification device 32 is a fingerprint scanner or other device for identifying clients and associating the clients with accounts maintained by the system 10. In another example, the identification device 32 is a magnetic stripe or smart (chip) card reading/writing device that enables the moderator to set and change cards associated with accounts for the clients.

Second, the disclosed system 10 has a client portion 14, which includes a remote client station 50 and one or more client terminals 60 in the present embodiment. The client portion 14 enables clients to search media available on the system 10 and to request that the media they select be played during the multimedia session. Preferably, the client terminals 60 are positioned in locations of the venue that are conveniently accessible to clients and that are remote from the host station 20 and moderator terminal 30. For example, the client terminals 60 may be positioned away from a stage or may be positioned in a private room reserved by clients for various multimedia activities.

In a further embodiment, the client portion 14 also includes an identification device 70. In one example, the identification device 70 is a fingerprint scanner or other device for identifying clients at the venue. In another example, the identification device 70 is a card reading/writing device for magnetic stripe cards or smart (chip) cards. The identification device 70 enables clients to access options available on the client terminals 60, to identify themselves as previous clients, to pay for selected media or other services, or to perform other available activities.

Lastly, the disclosed system 10 has a performance portion 16, which includes media devices 80 and 90, a playlist station 40, and a playlist monitor 100 in the present embodiment. The performance portion 16 provides the audio and visual aspects of the multimedia session. Preferably, some components of the performance portion 16 are located in public areas of the venue, such as on a stage.

The first media device 80 is an audio system, which can have one or more amplifiers 82, speaker systems 84, and microphones 86. The second media device 90 is a video system, which can have a video projector 92 and screen 94 or can have an integrated video display, such as HDTV, LCD, or Plasma display. The playlist station 40 is communicatively coupled to the host station 20 and to the playlist monitor 100. In general, the playlist station 40 and monitor 100 display what media selections are queued to be played and can inform clients where their selections are positioned in the queue. In another embodiment, the playlist station 40 can be communicatively coupled to an alert device 44 used to alert clients of their status in the queue. For example, the alert device 44 can be a wireless paging system or the like that sends alert signals to associated devices distributed to the clients at the venue. In yet another embodiment, the performance portion 16 can also include a camera and DVD recorder for recording performances by clients.

It is understood that the system 10 can have a different configuration than shown in FIG. 1. For example, the system 10 can have several separate performance portions 16 coupled to the host station 20. These separate performance portions 16 can be positioned at different locations or rooms of a venue. Each of the separate performance portions 16 can have an associated client station 50 and client terminal 60 and can have its own playlist station 40 and monitor 100. Therefore, the host station 20 can be configured to generate and process separate rotating queues of requested media selections for each of the different locations or rooms at the venue or among suitably linked venues.

Given the overview of the system 10 presented above, discussion now turns to details of various components of the system 10. The host station 20 can include one or more computers, servers, or other processing devices. The host station 20 is networked to one or more remote client stations 50, which in turn are connected individually or collectively to a plurality of client terminals 60. The client station 50 can include a computer, a server, or other processing device. It is understood that several terminals 60 may be operated with one client station 50. The host station 20 is also networked to the playlist station 40, which in turn is connected to the playlist monitor 100. The playlist station 40 can include a computer, a server, or other processing device.

It is understood that the host station 20, playlist station 40, and/or client stations 50 can be part of one computer system or can be separate computer systems networked together as shown in FIG. 1. However, using separate host station 20, playlist station 40, and client stations 50 efficiently separates the functions performed by these systems and can reduce the need for multitasking and switching among video outputs, for example. The host station 20, playlist station 40, and client stations 50 can use any standard network available in the art, including, but not limited to, Ethernet, Local Area Network (LAN), and wireless network.

During operation, the clients can send search queries to the host station 20 and can receive search results from the host station 20 via the client stations 50 and client terminals 60. In addition, the client can send requests for media selections from the client stations 50 and terminals 60 to the host station 20. Communication between the client station 50 and the host station 20 can use techniques known in the art, such as using network streams of packets.

In a preferred embodiment, the client terminals 60 feature touchscreen displays for the clients to search, input, and review data. The client station 50 offers a graphical user interface (GUI) on the touchscreen display 60. Using the touchscreen GUI on the displays 60, the clients can enter information about themselves and can search multimedia files stored on the system 10 (e.g., files stored in databases associated with host station 20). When searching, the client station 50 compiles and sends user-defined media queries to the host station 20. In addition to searching, clients can make various selections and requests with the touchscreen displays 60. To make the requests, the client enters information or makes a selection with the touchscreen display 60, and the client station 50 compiles and sends the request to the host station 20.

In a preferred embodiment, the clients use the identification devices 70 to access the system 10 and interact with the client station 50 and touchscreen displays 60. In one exemplary embodiment, the identification device 70 is a magnetic stripe card reader. Clients at the venue are provided with magnetic stripe cards that have a pre-paid account and a unique identification associated with them. To access the touchscreen display 60, the client swipes her card at the reader 70, and information about the client is retrieved from database(s) associated with the host station 20. Then, as the client makes media selections, the host station 20 associates the client's card number with the client's entered user name along with all of the client's current and historical media selections, tabulates remaining card value balance, and updates and stores this information on the databases at the host station 20.

In an alternative exemplary embodiment, the identification device 70 is a device for reading and writing information stored in smart cards, which are configured to store information (e.g., name, balance, selection history, etc.) about the clients within the cards themselves for later recognition and retrieval at the venue or by an identically configured host station 20 at another venue. In this way, the client information can be compiled and stored on the smart cards as well as at the databases of the host station 20.

In one embodiment, the host station 20 includes one or more servers. In one exemplary embodiment, the host station 20 can have one server capable of performing the various functions disclosed herein. In another exemplary embodiment, the host station 20 can have one server for handling requests and searches for multimedia files and can have another server for processing the multimedia files and outputting processed data to the one or more of the media devices 80 and 90 of the performance portion 16.

The host station 20 has one or more databases associated with it, which can be stored on one or more dedicated hard drives associated with the host station 20. The databases are preferably based on Sequential Query Language (SQL) and respond to several preprogrammed query variations. Media files, which include, but are not limited to, karaoke, music, video, and/or still images files, are stored in the databases of the dedicated hard drives associated with host station 20. The host station 20 enables independent, remote, and advanced search queries of the databases based on the title, artist, genre, media type, producer, and other “hidden” information that can only be selected by the moderator from the host station 20. Server based searches are preferably segregated by media type (e.g., audio, video, karaoke, and/or still images) into unique folders.

In response to a search query from the client station 50, the host station 20 returns search results to the client station 50 for display on the touchscreen display 60 of the requesting client. The search results can be an alphabetically ordered list of possible songs, videos, etc. found using a best match search or other algorithm. After reviewing the search results, the client can refine the search, initiate a new search query, or make a media selection from the displayed results. In all of these instances, the client station 50 preferably communicates the search action or media selection from client's touchscreen 60 to the host station 20.

During operation, the host station 20 establishes a rotation schedule as new clients enter the rotating queue for the first time. As clients request additional media selections, the host station 20 assigns these subsequent media requests to the playlist in the order of each client's place in the rotation based upon an imbedded set of rules which may be modified by the moderator. These rules can be used to preserve a client's place in the rotation schedule even when an additional media selection has not been requested for a period of time during the session.

The host station 20 continually or intermittantly sends updated playlist information to the playlist station 40, which in turn displays the playlist information on the monitor 100 for the clients to view publicly. The playlist information can only include the user names of the clients who have made media selections. Preferably, the playlist information sent from the host station 20 to the playlist station 40 includes the clients' user names, the titles of their selections, the play period lengths, the play positions in the rotating queue, and other pertinent information. The playlist information is preferably sent as a network stream of packets from the host station 20 to the playlist station 40. At the playlist station 40, software processes the received information and outputs the playlist to the monitor 100 or other display equipment.

During operation, the host station 20 also sends video and image output to remote video monitors, projectors, and displays. The host station 20 can send the video and image output using any of the various formats and connections known in the art, such as VGA, RCA, and S-video. For example, the host station 20 can send output from video or image media currently playing at the host station 20 to the video monitor or projector system 90 through an S-video, RCA, or VGA connection 22. Likewise, the primary playlist can be relayed from the playlist station 40 to the video monitor 100, with such a connection 42. Furthermore, the host station 20 can send audio output through an audio connection 24 known in the art, such as audiophile quality digital and analog connections. For example, audio output can be sent to the audio system 80 via RCA stereo or digital coaxial connections. In an alternative embodiment, the host station 20 can use wireless audio and video transmissions to the audio system 80 and/or video system 90. Furthermore, the host station 20 can drive the audio system 80 and the video system 90 over the network.

The disclosed system 10 can be configured to operate in an automated fashion, to operate manually, or to operate with a combination of both manual and automated operation. For example, one or more of the acts of receiving the requests from the client terminals 60, storing the requests in a queue, establishing and adjusting a rotation schedule as clients join the queue, and cycling through the requests in the queue can be automated. The automation can be by default or can have attributes configurable at the host station 20. In this way, automated operation of the disclosed system 10 can be performed without requiring subsequent manual intervention by the moderator or DJ/KJ.

In one embodiment, the system 10 can be automated to store media files, to store the requests for media files, to retrieve the requested media files, and to play/display the media files at the host station 20. For example, without requiring manual intervention by the moderator, the host station 20 can automatically queue and manage the requests made by a plurality of clients from the touchscreen displays 60 during the multimedia session. At the host station 20, the requests are placed into a main queue or primary playlist. The primary playlist includes the media selections from the various clients according to a rotation scheme established as the clients request media selections and enter the rotating queue. In one embodiment, the first and any subsequent media selections from a particular client can be chronologically ordered into the rotation schedule according to when the first selection was made by that client. Then, without requiring manual intervention, the host station 20 can automatically play/display the media selections in the order they have been entered in the rotating queue.

The automated aspects of the host station 20 can be pre-configured by the moderator before or during the multimedia session. In addition, the moderator can use the moderator terminal 30 during the media session to intervene manually in the automated operation of the system 10. For example, the moderator can manually alter the order of the playlist, manually add or delete media selections from the playlist, or manually control the playing of the media selections.

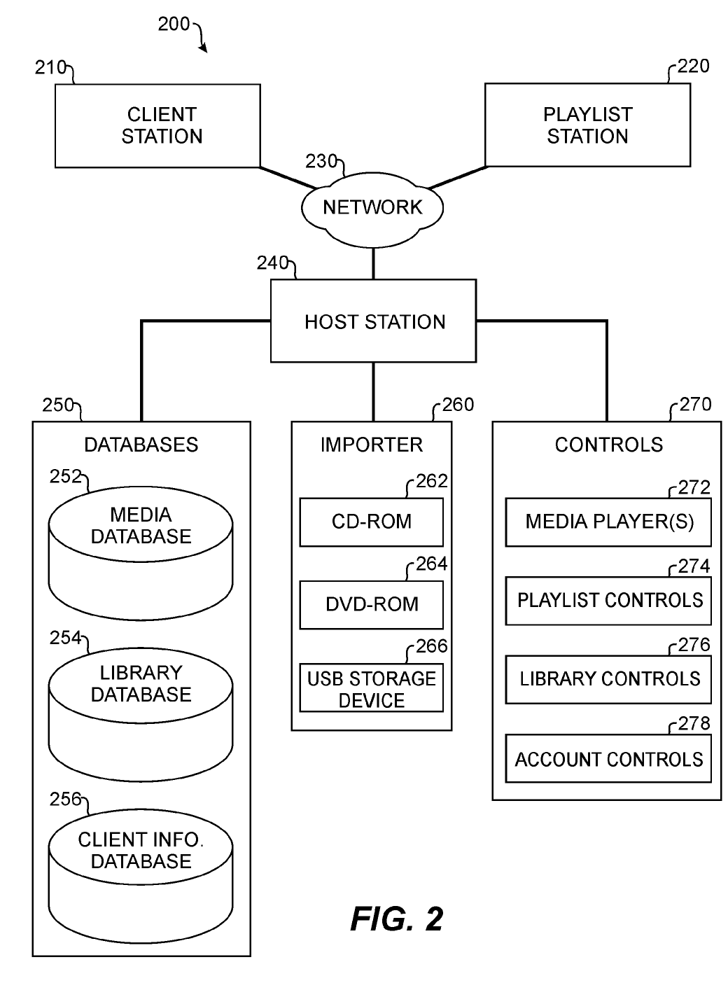

Referring to FIG. 2, elements of the disclosed system 200 are schematically illustrated in more detail. As alluded to above, one or more client stations 210 and a playlist station 220 are communicatively connected to host station 240 via a network 230. The network 230 can be any standard network used to connect computer systems and peripherals together, such as an Ethernet, LAN, or a wireless network.

The host station 240 has one or more databases 250, an importer 260, and controls 270 associated with it. The databases 250 include a media database 252, a library database 254, and a client information database 256. These databases 250 are preferably SQL-based and can be stored on one or more dedicated hard drives (not shown) associated with the host station 240. The media database 252 stores media files, which include audio files, video files, karaoke files, and/or images files. The media files can have various file formats, including, but not limited to, WMA (Windows Media Audio), WMV (Windows Media Video), MP3 (Moving Pictures Expert Group (MPEG)-1 Layer 3 Audio), AVI (Audio Video Interleaved), JPG, CDG, and WAV (Waveform Audio Format). In addition, the audio files can accommodate lossy or full digital fidelity lossless compression.

The library database 254 stores information about the media files, such as the media titles, artists' names, play length times, producers, genres, formats, URLs (i.e., the path or location of the file on the system 200), and playcounts for each corresponding file in the media database 252. The clients can access information in the library database 254 for searching and selecting available media files. The moderator can access and modify information in the library database 254 for searching the information and performing other administrative purposes. The library database 254 can also store additional access control information that normally is hidden from clients and sometimes from moderators as well. For example, the hidden information can be a boolean (true/false) value indicating whether or not the corresponding media file is accessible in public searches.

The client information database 256 stores information about the clients. The client information can include user names, passwords, account balances, card identification numbers, and media selection histories, among other possible information. In one embodiment, the venue can require clients to open pre-paid accounts. In one example, a user name and password can be associated with the client's account, and the information can be stored in the client information database 256 so the client can access services available by the disclosed system. In another example, the venue can assign cards having identification numbers to the clients and associate the identification numbers with the clients' pre-paid accounts. When the client swipes her card in identification device (70; FIG. 1), the client information in the database 256 can be accessed and updated.

Among various options available at a venue, the venue can charge clients and update the client information database 256 when the clients request media selections, request to improve their queued position in the playlist, play games on the client terminals, or perform other activities with the disclosed system. The client information database 256 can also maintain historical records of the clients so that the system can identify the clients during return visits and can present them with their previous selection histories before they commence a new search query. In addition, the client information database 256 can also facilitate a voting scheme for performing and non-performing clients at a venue during contests.

The importer 260 is a software utility at the host station 240 that is used to import media files and other information from various devices including, but not limited to, a CD-ROM 262, a DVD-ROM 264, and USB storage device 266. For example, the importer 260 enables the moderator to rip or copy CD and CD+G audio tracks, compressed audio files, compressed video files, and compressed image files from the various devices 262, 264, and 266. The ripped or copied files and tracks are preferably encoded with Windows Media Encoder into corresponding Windows Media formats (e.g., WMA with CDG, WMV, and JPG) and are copied to the media database 252 of the host station 240. The importer 260 is preferably developed with Goldenhawk C++ Software Developer Kit (SDK), and the system 200 preferably uses a CD-ROM that is CD+Graphics Certified to import CD+G Karaoke files to the media database 252. Video, audio, and image files may be imported directly if the files are already compressed into a Windows Media Player compatible format. Otherwise, the files can be automatically compressed into a respective Windows Media format (e.g., WMV, WMA, JPG) with the importer 260.

In addition to importing from associated devices, the disclosed system 200 can have Internet functions to download from various sources on the Internet any media files (audio, video, karaoke, and/or still images) in various formats, licensing protocols, etc. The downloaded media files can be stored on the system 200 or can be delivered directly to the performance portion (16; FIG. 1) for live performances. Moreover, the Internet functions can provide for software downloads so that software of the disclosed system can receive patches and upgrades from a remote source over the Internet.

The controls 270 include software for controlling the system 200 and have graphical user interfaces for the moderator to control aspects of the system 200. The controls 270 include one or more media player controls 272, playlist controls 274, library controls 276, and account controls 278. The media player controls 272 are preferably developed with Windows Media Player Software Developer Kit (SDK) and Power Karaoke CD+G Software Developer Kit (SDK). The media player controls 272 play the media files in the media database 252 and include a video filter for processing karaoke files. Further details of the media player controls 272 are disclosed below with reference to FIG. 4.

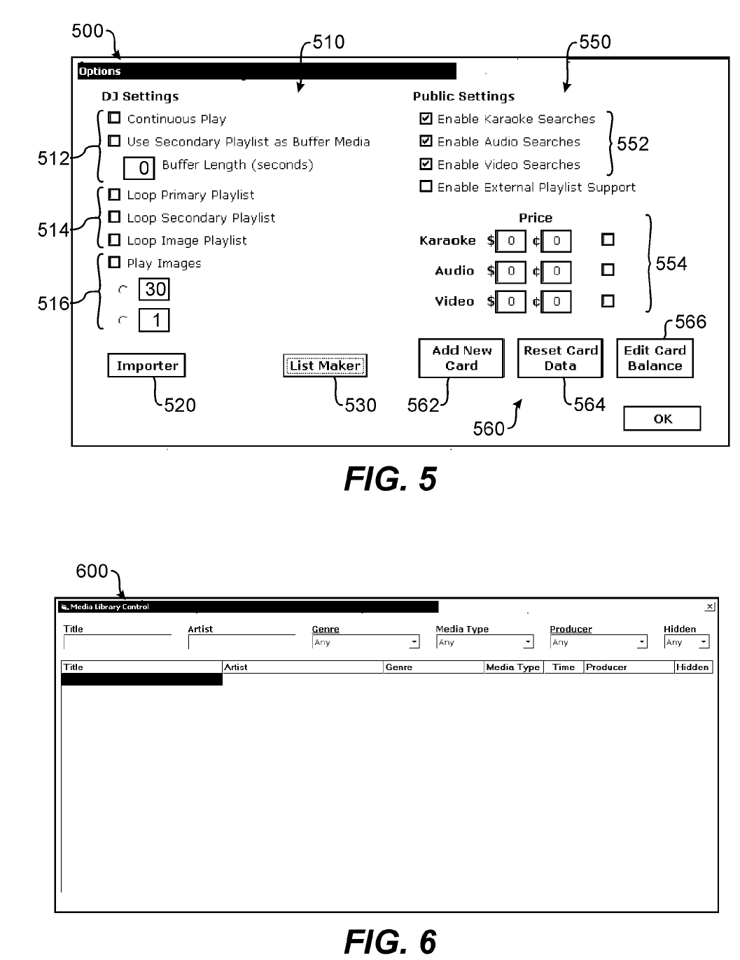

The playlist controls 274 enable the moderator to manipulate the active playlist station 220 containing the rotation queue of media selections from the clients. For example, the playlist controls 274 enable the moderator to edit the positions of media selections in the playlist, add or delete media selections from the playlist, store playlists, and stop/play/pause playing of the media files, among other functions disclosed herein. Further details of the playlist controls 274 are disclosed below with reference to FIGS. 4 and 5.

The library controls 276 enable the moderator to search and edit the media files in the media database 252 and to search and edit the media information in library database 254. For example, the library controls 276 enable the moderator to remove media files from the media database 252, edit media file identity information in the library database 254, and perform advanced searches of information and files in the databases 252 and 254. Further details of the library controls 276 are disclosed below with reference to FIGS. 4 through 8.

The account controls 278 enable the moderator to add, edit, and delete account information for clients at the venue. For example, the account controls 278 enable the moderator to configure account and card information for the magnetic stripe or smart cards used by clients at a venue. Further details of the account controls 276 are disclosed below with reference to FIG. 5.

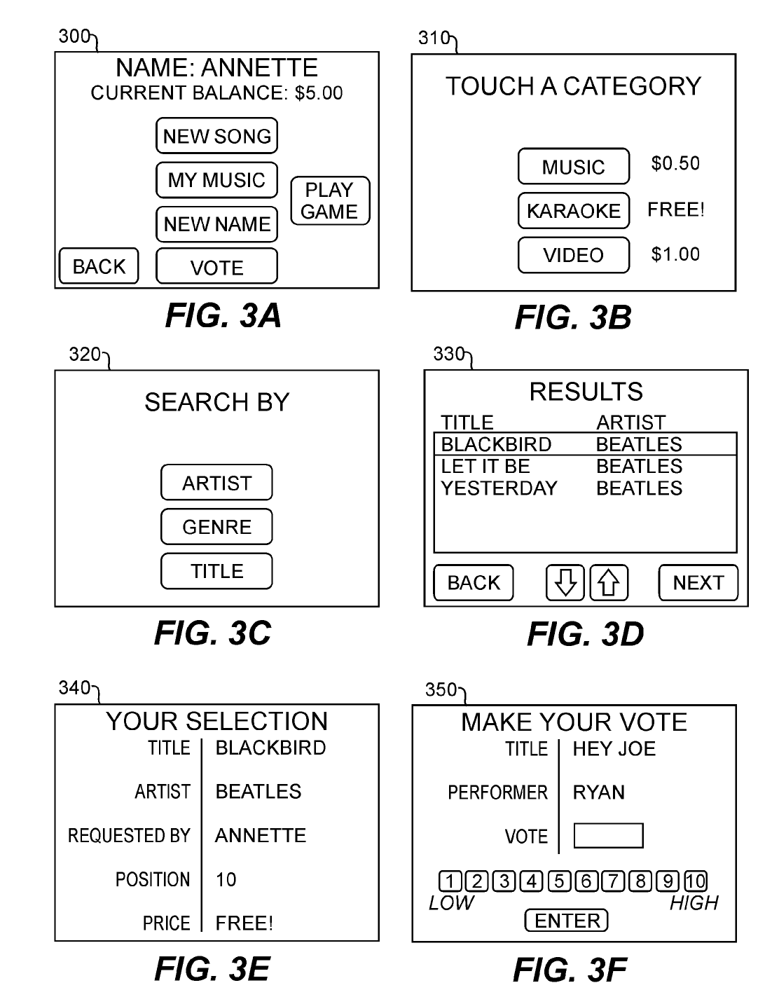

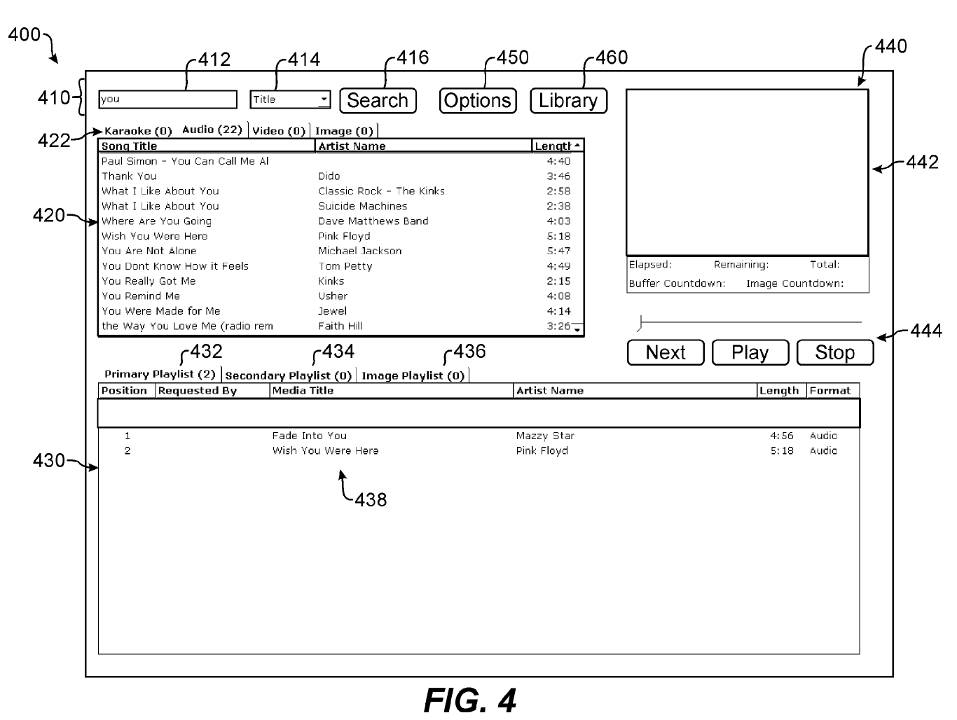

Referring to FIGS. 3A-3E, embodiments of touchscreen interfaces available to clients at a venue are illustrated. As noted in FIG. 1 and described above, the venue has one or more touchscreen displays (60; FIG. 1) and remotely networked client stations (50; FIG. 1) for the clients to conduct searches and select media at a venue. To use the touchscreen interfaces, the client may be prompted to enter a unique user name. Entering the user name can be done manually with a keypad available on the touchscreen of the display. Alternatively, the system can be configured to accept and recognize clients using a fingerprint scan or using magnetic stripe or smart cards disclosed herein to access the touchscreen interfaces at a venue. Each card has an account and user name associated with it, and the information is stored on the system during a client's first query and queuing experience. In one embodiment, clients use their magnetic stripe or smart card to access the touchscreen interfaces for priced services, thereby affiliating and retrieving client user name, balance, and other information from a previous session. Alternatively, one or more services may be free, and the clients may only have to swipe their cards for those services that cost a fee.

To make a media selection, the client first views a main menu 300 shown in FIG. 3A on the touchscreen display. When the client accesses the interface, the name and balance associated with the client's account can be accessed and displayed on the main menu 300. From the main menu 300, the client can select a “New Song” option, a “My Music” option, a “New Name” option, and a “Back” or cancel option. By choosing the “New Name” option on main menu 300, the client can edit the name associated with her card. By choosing the “My Music” option on main menu 300, the client is presented a list of previously selected media for the client's account, from which the client can make repeat media selections.

When the client chooses (touches) the “New Song” option, the system displays a media selection menu 310 shown in FIG. 3B. The media selection menu 310 presents categories of media available for selection by the client. For example, the client can choose a “Music” category to select audio music to be played by the system; the client can choose a “Karaoke” category to perform karaoke, or the client can choose a “Video” category to select a video to be played by the system. Each of these categories can have a price associated with it so that the client can use her prepaid card to pay for the activities. When an option is selected, the system applies the client's choice to her account. For example, in the case of a Karaoke selection the system provisionally decrements the performer's account to the appropriate new balance and later it either confirms that new balance when the selection plays or restores the former balance if the performer or moderator cancels the selection before it plays.

After selecting a category, the client then searches the corresponding music, karaoke, video, and/or image media available on the system. As shown on a search touchscreen 320 in FIG. 3C, the client can search the available category of media by artist, genre, or title. After selecting the search criteria, the client is presented with a touchscreen keypad interface (not shown) for entering search information (e.g., artist name). Typical search criteria can be used. For example, one or more key words in the title/artist name may be acceptable to build a query, and words that are misspelled by up to two letters may still yield results. In addition, searches can be made based on a combination of critieria, such as genre and title, for example.

After clients enter the search criteria, the system searches the media information stored in the library database (254; FIG. 2) which contains the titles, artists, genres, etc. of the media files stored on the system. The search results are then displayed on a result screen 330 as shown in FIG. 3D. Preferably, results are ordered alphabetically, and duplicate media files only return one result. Clients use arrow buttons on the screen 330 to move a highlighted cursor to a desired media result and select “Next” to make their selection and proceed to the next screen. Using the back button enables clients to return to the search entry screen to conduct another search.

Once the client has made a selection, a description screen 340 is displayed to the client. The description screen 340 shows the title, artist, client user name, position of her media selection in the rotating queue of the playlist, the price of the media selection, and approximate time remaining for media to play, among other possible information. Once the client approves the summary information on the description screen 340 by touching “Next” (not shown, but similar to Results screen 330) the client's media selection (e.g., music, karaoke, video, and/or image) instantly becomes part of the playlist at the venue. In particular and as shown in FIG. 1, the client station (50) sends the client's request (e.g., client's name and media selection) to the host station (20) of the system (10). In turn, the playlist is sent to the playlist station (40) and monitor (100) shown in FIG. 1 or other similarly integrated device (not shown) to advise or alert clients to their status in queue.

The touchscreen interfaces can offer additional activities or services for clients. For example, clients at a venue can access real-time voting using a “Voting” option on the main menu 300 of FIG. 3A. When voting, the client access a voting menu 350 as shown in FIG. 3F to vote on live karaoke performances at a venue. In another example, clients at a venue can access games using a “Play Game” option on the main menu 300 of FIG. 3A. The games are run on the client stations and touchscreen displays and can require a fee. The games can be individual games for one client. Alternatively, multiple-user gaming can be provided via the network of client stations and touchscreen displays at a venue or, additionally, among identically configured venues via the Internet.

In an additional embodiment, the touchscreen interface on the client terminals can include links for the client to download multimedia files into a portable MP3 player, other device, or storage medium. The download link can be associated with the client's account, and a fee for the download can be deducted from the account.

Referring to FIG. 4, an embodiment of a host station interface 400 of the disclosed system is illustrated. The host station interface 400 is available in the moderator terminal (30; FIG. 1) for a moderator at a venue to access and control the host station (20; FIG. 1). The host station interface 400 includes a search section 410, a search result listing 420, a playlist section 430, and a play control section 440. From the host station interface 400, the moderator can also access options 450 of the disclosed system and can access the library 460 of media.

The search section 410 enables the moderator to enter one or more search words 412 (e.g., “you”) and search criterion 414 (e.g., “title”) to locate media files of the disclosed system meeting the search parameters (e.g., including the word, “you,” in the title). By selecting search 416, results of the search are shown in the search result listing 420. The search results are listed under tabs 422 for the different formats of media files stored on the disclosed system. These different formats includes Karaoke, Audio, Video, and/or Images having separate tabs 422 for the listing 420.

The playlist section 430 displays the various queues or playlists 438 developed by the clients at their touchscreen displays and developed by the moderator. The playlist section 430 has playlists 438 that are separated by playlist tabs 432, 434, and 436. There is a primary playlist 432, a secondary playlist 434, and an image playlist 436, which are the active queues of respective media organized to be played by the system. The primary playlist 432 includes those selections for audio, video, karaoke, and/or images requested by the clients from the touchscreen displays. The secondary playlist 434 is intended to complement the primary playlist 432. For example, the secondary playlist 434 contains media that is played between karaoke performances, songs, and music videos contained on the primary playlist 432. The image playlist 436 contains a list of images that are displayed during songs or between the media played on the primary playlist 432. The image files in the system and the image playlist 436 may be accessible to users at a venue or may only be accessible to the moderator at the host station (20; FIG. 1).

As disclosed herein, media selections from clients are automatically added to the playlist 438 in the primary playlist 432, and the playlist 438 cycles through the media selections based on the order of their original entry in an automatic rotation scheme which may be modified by the moderator. The playlist 438 shows the position, title, artist name, length, and format of the media selections. In addition, the playlist 438 shows the user names of the clients who requested the media selections. Accordingly, the host station (20; FIG. 1) stores this descriptive information in memory along with the actual locations (e.g., links, pointers, URLs) of the selected media files requested by the clients. In addition, this descriptive information of the playlist 438 is sent from the host station (20; FIG. 1) to the playlist station (40: FIG. 1) so that the public display of the primary playlist on the monitor (100; FIG. 1) or other device can be routinely updated. In an alternative embodiment, a rotation display shows only the clients by user name in the order of their joining the playlist queue at the time of their initial media request.

Although the media selections are added automatically to the primary playlist 432, the moderator can modify each of the playlists 432, 434, and 436. For example, the moderator can add media selections to and delete queued media selections from these playlists 432, 434, and 436. In another example, the moderator can limit the number of media selections per user that can be queued in these playlists 432, 434, and 436. In a further example, the moderator can select a search result from the listing 420 and add the result to the playlist 438 using standard interface actions, such as double clicking a search result in the results listing 420. Also, the moderator can delete media selections in the playlist 438. Moreover, the moderator can change the order of media selections in the playlists 438 using drag and drop techniques.

The play control section 440 has a viewer 442 and play controls 444. The viewer 440 displays the current output of the media file being played by the system. The play controls 444 include a “Next” control, which moves all media selections in the playlist 438 forward one entry. The play controls 444 also include Play/Pause, and Stop controls and include a play position slider to adjust the current play position of a media selection. The viewer 442 and play controls 444 operate the media players of the system, which preferably include Windows Media Player 10 and Power Karaoke CD+G. With the play controls 444, the moderator can start, stop, and pause the playing of the media selections in the playlist 438. However, as disclosed herein, such intervention by the moderator is not required because the media selections can be set to play automatically in ordered, random, and/or repeating sequences.

When playing the media selections, the host station (20; FIG. 1) automatically processes the media files associated with each media selection in the playlist 438 by cycling through the selections in the playlist 438. The playlist 438 is stored as a database table on the host station (20; FIG. 1). The database table includes the information shown on playlist 438 of FIG. 4 but also includes the location (e.g., URL, file destination, etc.) of the actual media file on the system. The media player 440 accesses the stored media file using the location (e.g., URL) of the media file associated with the media selection in the playlist 438. Then, the media player 440 processes the input data from the accessed media file and generates output data that is sent to the various media devices (e.g., audio system 80 and video system 90 in FIG. 1) connected to the host station (20; FIG. 1).

Referring to FIG. 5, an option interface 500 for the moderator of the disclosed system is illustrated. As noted above, this option interface 500 can be accessed from the host station interface (400) of FIG. 4 using the “Options” button (450). The option interface 500 includes moderator or DJ/KJ settings 510 and public settings 550. The moderator settings 510 include play options 512 for setting overall operation of the disclosed system, loop options 514 for setting the looping of the playlists, and image options 516 for controlling the display of images. The moderator settings 510 also include a button 520 to access the importer utility disclosed herein and another button 530 to access a list maker utility disclosed herein.

The play settings 512 enable the moderator to configure the system for continuous play so that media selections are automatically queued in their respective playlists, played, and cycled in the rotating queue. Using the play settings 512, the moderator can also set a time interval as a buffer (e.g., in seconds) between playing the media selections of the playlists. In addition, the moderator can set the media selections in the secondary playlist to play as buffer media between media selections in the primary playlist. Furthermore, the moderator can configure the system so that beginning and ending portions of the media selections in the playlists overlap one another when being played. Thus, the play settings 512 enable the moderator to set an overlap time duration and a volume fade so that the media selections can be seamlessly played when one selection ends and the next selection begins.

The loop settings 514 enable the primary, secondary, and image playlists noted above to be individually looped. Looping in this context means that the media selections in these playlists are recycled when the end of the playlist queue is reached. Additional settings may permit the playlists, such as the secondary playlist, to run randomly. The image settings 516 enable the moderator to cause the system to display still images automatically when no other video source is active (i.e., when an audio track is playing alone). The images can be displayed according to a time value per image or according to a number of images per audio track.

The public settings 550 enable the moderator to control the search options settings 552 available to clients. For example, the moderator can enable or disable karaoke searches, audio searches, video searches, or external playlist support. In addition, the public settings 550 enable the moderator to set pricing 554 for the various activities provided by the disclosed system, including but not limited to, those depicted in FIG. 5. Finally, the public settings 550 feature prepaid card controls 560, which access functions to enable the moderator to access and update information of the prepaid cards and accounts of the clients. For example, using the “Add New Card” button 562, the moderator can activate and add a new client card, assign an optional client user name, and establish an initial account balance in the card. Using the “Reset Card Data” button 564, the moderator can reset all the information associated with a card to extend the card for the current client or to recycle the card for a new client, among other options. Using the “Edit Card Balance” button 566, the moderator can adjust the account balance associated with the card, for example, when a client wishes to add purchase value to the balance of the card. When these controls 560 are selected, the moderator accesses various interfaces (not shown) for performing these functions, and the moderator may be prompted to swipe a prepaid card in a card reading device associated with the moderator terminal when entering or changing information associated with the swiped card.

Referring to FIG. 6, a media library control interface 600 for the moderator is illustrated. As noted above, this library interface 600 can be accessed from the host station interface (400) of FIG. 4 using the Library button (460). The library interface 600 enables the moderator to perform advanced searches for media files using title, artist, genre, media type, producer and certain hidden information. The moderator can also edit and remove existing media files with the library interface 600 using standard user interface functions.

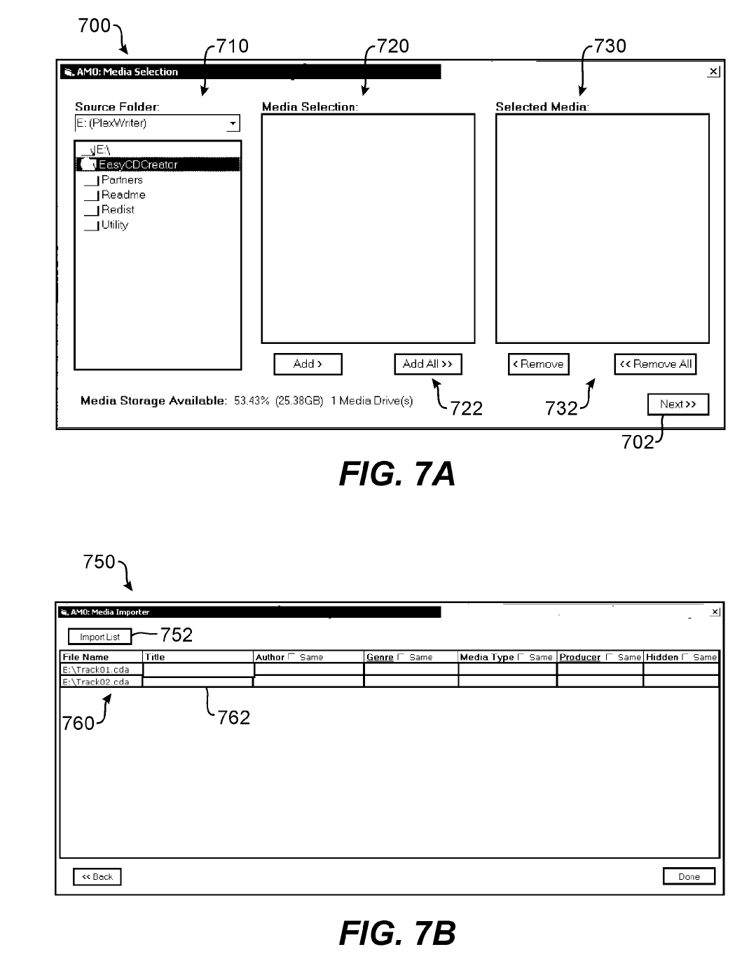

Referring to FIGS. 7A-7B, importer interfaces 700 and 750 for the importer utility of the disclosed system are illustrated. As noted above, these interfaces 700 and 750 can be accessed from the option interface (500; FIG. 5) using the Importer button (520; FIG. 5). The first importer interface 700 enables the moderator to import media files from various sources, such as CDs, DVDs, USB storage devices, etc. The media selection interface 700 has a source folder 710, a media selection 720, and a selected media 730. The source folder 710 enables the moderator to select a source device (CD-ROM, DVD-ROM, USB device, etc.) associated with the host station (20; FIG. 1) from which to import media files. When the moderator selects a source device, those media files having file formats compatible with the system are listed in the media selection display 720. The moderator then uses the “Add” or “Add All” buttons 722 and the “Remove” or “Remove All” buttons 732 to move media files selected in the media selection display 720 to and from the selected media display 730.

After selecting media files to import, the moderator selects the “Next” button 702 to access the media importer interface 750 of FIG. 7B. In this interface 750, the selected files 760 are listed. In one embodiment, the moderator can manually input the title, author, genre, media type, producer, and hidden information 762 of media files with a keyboard or the like. The moderator can automatically “fill all” selections in a data column using the “Same” checkboxes. In another embodiment, the moderator can use an import list function 752 to access a data table stored elsewhere in the system for importation into the media importer interface 750.

In yet another embodiment, the importer utility can use techniques known in the art to automatically import descriptive information directly from the media files. For example, the system can detect media, such as CDs, and then automatically obtain descriptive information from the “Escient-CDDB” or “FreeDB” databases or Internet Server using appropriate protocols. When the moderator selects “Done” (shown in the lower right of FIG. 7B), the importer utility imports the media files from the source and stores them in appropriate folders in the databases associated with the host station (20; FIG. 1) of the disclosed system. In addition, the descriptive information of the media file, such as the title, author, etc., are stored in the library database (254; FIG. 2); of the disclosed system.

Preferably, the importer utility copies compressed files directly to the databases of the media hard drives. Uncompressed audio files are automatically losslessly compressed with Windows Media Encoder into the WMA format and copied to the databases of the media hard drives. CD+G graphics are extracted and added to the databases of the media hard drive. The importer utility is preferably configured to add the media files and the library information automatically into proper forlders of the databases of the system. This allows the media files and library information to be more readily accessed during searching and other operations of the disclosed system. For example, the media files may be stored in folders for each category of media available on the system, including an audio folder, video folder, karaoke folder, and image folder. Moreover, the various formats of files may be stored in separate folders. Also, the library information, for example, may be similarly stored in audio folders, video folders, karaoke folders, and image folders. Other techniques of database managment known in the art can be used to facilitate searching and accessing the information and data files.

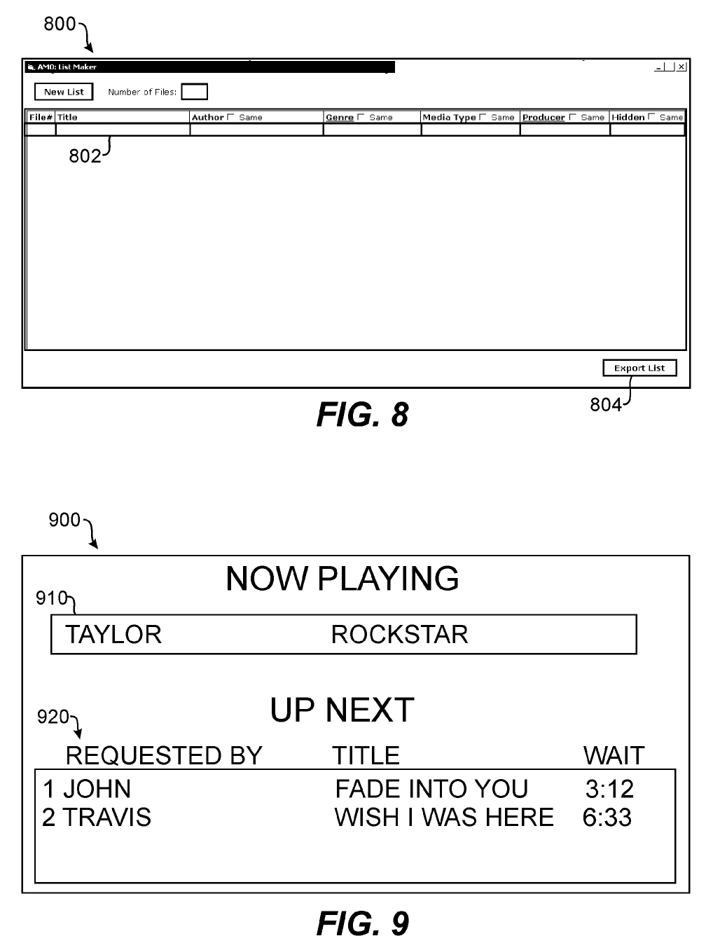

Referring to FIG. 8, a list maker interface 800 for the moderator is illustrated. As noted above, the moderator can import a list using the “Import List” button (752) on the media importer interface (750; FIG. 7). The list maker interface 800 enables the moderator to create and display a data table of entries 802 for the importer utility so that identification information (e.g., title, artist, etc.) of the media files can be added before media is inserted into, connected to, or otherwise loaded into the host station (20; FIG. 1). When the data table is created, it can be exported 804 to be associated with its respective media files and saved on the disclosed system by the importer utility.

Referring to FIG. 9, a playlist screen 900 for publicly displaying the media playlist is illustrated. As noted above, the playlist station (40; FIG. 1) is connected by various means to a video monitor (100; FIG. 1) or other advisory/alertment display device, which shows the primary playlist for the multimedia session. The playlist screen 900 shows the client's user name and media title of current media playing 910. In addition, the playlist screen 900 shows content of other, subsequent media selections 920 in the primary playlist. These media selections 920 are listed with a summation of individual media play lengths for all preceding media selections, which clients can use to approximate the waiting time for their media selection to reach the top of the queue. In one embodiment of operation, clients who have joined the rotating queue but who have not yet requested a subsequent media selection will retain their active position in the queue for an arbitrarily determined number of passes with a zero time value assigned for computing the waiting period for other subsequent users in the queue.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A system for conducting a multimedia session for users at a venue with one or more media devices, the system comprising:
a host station communicatively connected to the one or more media devices, the host station including at least one database for storing multimedia files and including software for processing the stored multimedia files; and
a client station for the users positioned remotely from the host station and communicatively connected to the host station via a communication path,
wherein the client station is configured to:
obtain requests from the users, the requests including user information and selections of stored multimedia files, and
transmit the requests, and
wherein the host station is configured to:
receive the requests,
generate a queue of the requests, the queue having the selections and the user information,
process the stored multimedia files of the requests with the software as each of the requests is cycled in the queue, and
output data of the processed multimedia files to the one or more media devices.

2. The system of claim 1, wherein the client station comprises a processing device, and a touchscreen display communicatively coupled to the processing device, wherein the client station has one or more touchscreen interfaces for making the requests.

3. The system of claim 1, wherein the host station comprises one or more networked servers.

4. The system of claim 1, wherein the client station is further configured to search information of the multimedia files stored in the database at the host station.

5. The system of claim 4, wherein to search the information of the stored multimedia files, the client station is configured to send search queries to the host station, and receive search results from the host station.

6. The system of claim 5, wherein the client station is configured to generate the requests based of the returned search results.

7. The system of claim 1, wherein the user information includes an identification of the user.

8. The system of claim 1, wherein the system is configured to store accounts for the users.

9. The system of claim 8, wherein the client station is configured to obtain account information from the users and transmit the account information to the host station.

10. The system of claim 9, wherein the client station further comprises a device communicatively connected to the client station to identify the clients.

11. The system of claim 9, wherein the host station is configured to receive the account information from the client station and update the account associated with the account information.

12. The system of claim 1, wherein the multimedia files comprise audio files, karaoke files, video files, or image files.

13. The system of claim 1, further comprising a playlist station communicatively connected to the host station via a communication path for publicly displaying the queue of the requests to the users at the venue.

14. The system of claim 1, wherein the software of the host station comprises a utility configured to:
import multimedia files from a source, and
store the imported multimedia files in the database.

15. The system of claim 1, wherein the host station is configurable to operate at least partially in an automated fashion during the multimedia session without requiring manual intervention.

16. The system of claim 1, wherein the queue of the requests is a primary queue, and wherein the software of the host station comprises a utility configured to enable processing of stored multimedia files in a secondary queue between processing of the requested multimedia files in the primary queue.

17. The system of claim 1, wherein the queue of the requests is a primary queue, and wherein the software of the host station comprises a utility configured to enable processing of images files in a secondary queue when processing the requested multimedia files in the primary queue.

18. A host station for conducting a multimedia session at a venue with one or more media devices, the host station communicatively connected to a client station via a communication path, the client station positioned remotely at the venue from the host station and having an interface for users to make requests, the host station comprising:
at least one database for storing multimedia files; and
software for processing the stored multimedia files,
wherein the host station is configured to:
receive requests from the client station, the requests including user information and selections for stored multimedia files,
generate a queue of the requests,
process the stored multimedia files of the requests with the software as each of the requests is cycled in the queue, and
output data of the processed multimedia files to the at least one media device.

19. The host station of claim 18, wherein the host station comprises one or more networked servers.

20. The host station of claim 18, wherein the host station is further configured to receive search queries from the client station, search for information of the stored multimedia files according to the queries, and return search results to the client station.

21. The host station of claim 18, wherein the multimedia files comprise audio files, karaoke files, video files, or image files.

22. The host station of claim 18, further comprising a playlist station communicatively connected to the host station via a communication path for publicly displaying the queue of the requests to the users at the venue.

23. The host station of claim 18, wherein the user information includes an identification of the user.

24. The host station of claim 18, wherein the software of the host station comprises a utility configured to:
import multimedia files from a source, and
store the imported multimedia files in the database.

25. The host station of claim 18, wherein the host station is configurable to operate at least partially in an automated fashion during the multimedia session without requiring manual intervention.

26. The host station of claim 18, wherein the queue of requests is a primary queue, and wherein the software of the host station comprises a utility configured to enable processing of stored multimedia files in a secondary queue between processing of the requested multimedia files in the primary queue.

27. The host station of claim 18, wherein the queue of requests is a primary queue, and wherein the software of the host station comprises a utility configured to enable processing of images files in a secondary queue when processing the requested multimedia files in the primary queue.

28. The host station of claim 18, wherein the software of the host station comprises a utility configured to:
associate accounts with the clients, and
obtain account information when enabling the clients to request the stored multimedia files.

29. A client station communicatively connected to a host station via a communication path and positioned remotely from the host station at a venue, the host station storing multimedia files and communicatively connected to one or more media devices, the client station comprising:
an interface for users to make requests and conduct searches of the stored multimedia files,
wherein the client station is configured to:
search for information of the stored multimedia files at the host station,
obtain user information,
generate requests for the users, the requests including the user information and selections of the stored multimedia files, and
transmit the requests to the host station for processing of the requested multimedia file and outputting of the processed multimedia file to the one or more media devices.

30. The client station of claim 29, wherein the client station comprises a processing device, and a touchscreen display communicatively coupled to the processing device, wherein the client station has one or more touchscreen interfaces for the users to make the requests and conduct the searches of the stored multimedia files.

31. The client station of claim 29, wherein to search for information of the stored multimedia files, the client station is further configured to send search queries to the host station, and receive search results from the host station.

32. The client station of claim 29, wherein the client station is configured to generate the requests based of the returned search results.

33. The client station of claim 29, wherein the multimedia files comprise audio files, karaoke files, video files, or image files.

34. The client station of claim 29, wherein the client station is configured to obtain account information from the users and transmit the account information to the host station.

35. The client station of claim 34, wherein the client station further comprises a device communicatively connected to the client station to identify the clients.

36. A method of conducting a multimedia session for users at a venue with a computer system, the computer system having a host station with memory and having one or more client stations for users positioned remotely from the host station, the computer system communicatively connected to one or more media devices, the method comprising:
storing a plurality of multimedia files in memory of the host station;
receiving requests from the one or more client stations, the requests including user information and selections for stored multimedia files;
storing the requests in a queue in memory of the host station; and
cycling through the requests in the queue with the host station by:
processing the multimedia files associated with the requests, and
outputting data of the processed media file to the one or more media devices.

37. The method of claim 36, wherein the multimedia files comprise audio files, karaoke files, video files, or image files.

38. The method of claim 36, further comprising electronically displaying the queue of the requests to the users at the venue with the computer system.

39. The method of claim 36, wherein the act of storing the multimedia files in memory of the host station comprises importing the multimedia files from a source, and storing the imported multimedia files in one or more databases associated with the host station.

40. The method of claim 36, further comprising enabling the users to search for information of the multimedia files stored in memory of the host station using the one or more client stations.

41. The method of claim 40, further comprising generating the requests for the users based on search results returned from the host station to the client stations.

42. The method of claim 36, wherein one or more of the acts of receiving the requests, storing the requests in the queue, and cycling through the requests is automated during the multimedia session without requiring manual intervention.

43. The method of claim 36, wherein the act of storing the requests for multimedia files in the queue in memory of the host station comprises:
associating locations of the multimedia files at the host station with the requests for the multimedia files; and
storing the associated locations and requests in memory.

44. The method of claim 43, wherein the act of processing the multimedia files associated with each request comprises:
accessing the stored multimedia file by using the location of the multimedia file of the request;
processing input data from the accessed multimedia file with software at the host station; and
generating output data from the input data with the software.

45. The method of claim 36, further comprising enabling processing of separate multimedia files in a separate queue between processing of the multimedia files of the requests.

46. The method of claim 36, further comprising enabling processing of images files in a separate queue while processing the multimedia files of the requests.

47. The method of claim 36, further comprising associating accounts with the users, and obtaining account information when the users make the requests for multimedia files.
